(19) United States
(12) Patent Application Publication
(10) Pub. No.: US 2026/0011180 A1
(43) Pub. Date: Jan. 8, 2026

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventor: KAZUFUMI ONUMA, Kanagawa (JP)

(21) Appl. No.: 19/258,591

(22) Filed: Jul. 2, 2025

(30) Foreign Application Priority Data
Jul. 8, 2024 (JP) 2024-109384

(51) Int. Cl. G06V 40/20; G06V 10/20; G06V 10/62; G06V 10/764; G06V 20/64; G06V 20/70

(52) U.S. Cl. CPC G06V 40/23; G06V 10/255; G06V 10/62; G06V 10/764; G06V 20/64; G06V 20/70

(57) ABSTRACT

An image processing apparatus is provided and acquires first shape information and second shape information representing three-dimensional shapes of a subject generated based on captured images at different imaging times, sets a first tracking point at a first imaging time and a second tracking point at a second imaging time based on the first shape information and the second shape information, and sets a common identifier as an identifier set for the second tracking point as the identifier for the first tracking point when a distance between a position of the first tracking point and a position of the second tracking point is less than or equal to a predetermined value.

### BACKGROUND

### Field of the Technology

The present disclosure relates to an image processing apparatus configured to track a subject.

### Description of the Related Art

There is a technology that generates a virtual viewpoint image captured from a viewpoint specified by a user using a plurality of images captured by an imaging system consisting of a plurality of imaging apparatuses. This technology can provide a virtual viewpoint image captured from a position where an imaging apparatus cannot be physically installed, in sports such as soccer or basketball.

In recent years, there has been demand for tracking the positions of subjects within video content in order to analyze their movements and utilize the results of the analysis. For example, in coaching or broadcast commentary relating to sports, there is demand for tracking athlete position information and displaying this information in association with statistical information, including team and/or individual athlete information.

As a subject position tracking method in virtual viewpoint image generation technology, Japanese Patent Application Laid-Open No. 2024-55093 discusses a method for estimating the position of a subject using a portion of an estimated three-dimensional shape at a predetermined height.

While conventional methods enabled subject tracking as required at the time, there has been increasing demand for subject tracking in various imaging environments in recent years. For example, in the case of imaging keirin, since a track course of a keirin velodrome includes a slope, the three-dimensional positions of athletes change significantly depending on their riding positions, making it difficult to track the subject. Further, in the case of capturing a movie using wire action, performers move through a three-dimensional space in various postures, making it difficult to track the subject.

### SUMMARY

The present disclosure is directed to facilitating subject tracking in various imaging environments.

According to an aspect of the present disclosure, an image processing apparatus includes one or more memories storing instructions, and one or more processors executing the instructions to acquire first shape information representing a three-dimensional shape of a subject generated based on a plurality of captured images at a first imaging time and second shape information representing a three-dimensional shape of the subject generated based on a plurality of captured images at a second imaging time, generate first distance information indicating a distance from a first position in a virtual space to the three-dimensional shape corresponding to the first shape information based on the first shape information and second distance information indicating a distance from a second position in the virtual space to the three-dimensional shape corresponding to the second shape information based on the second shape information, set a first tracking point of the three-dimensional shape corresponding to the first shape information at the first imaging time based on the first distance information, set a second tracking point of the three-dimensional shape corresponding to the second shape information at the second imaging time based on the second distance information, and set a common identifier as an identifier set for the second tracking point as the identifier for the first tracking point when a distance between a position of the first tracking point and a position of the second tracking point is less than or equal to a predetermined value.

Features of the present disclosure will become apparent from the following description of embodiments with reference to the attached drawings. The following description of embodiments are described by way of example.

### BRIEF DESCRIPTION OF THE DRAWINGS

FIG. 1 is a block diagram illustrating an example of an image processing system.

FIG. 2 is a flowchart illustrating a process of setting a detection point of a subject by a subject position detection unit.

FIGS. 3A to 3E are diagrams illustrating details of the process of setting a detection point of a subject by the subject position detection unit.

FIG. 4 is a diagram illustrating a coordinate system in a track competition.

FIG. 5 is a diagram illustrating a superimposition image displaying the velocities of subjects.

FIG. 6 is a diagram illustrating a superimposition image displaying the trajectories of subjects.

FIGS. 7A and 7B are diagrams illustrating display screens used during the assignment of subject identifiers to detection points based on user operations.

FIGS. 8A and 8B are diagrams illustrating a process of setting a virtual viewpoint by a viewpoint instruction unit using tracking information and subject identification information.

FIG. 9 is a diagram illustrating an example of a hardware configuration of an image processing apparatus.

FIG. 10 is a flowchart illustrating a process of generating tracking information by a tracking unit.

FIG. 11 is a flowchart illustrating a process of associating a tracking identifier with a subject identifier by a smoothing unit.

FIG. 12 is a diagram illustrating a mapping table indicating combinations of tracking identifiers and subject identifiers.

### DESCRIPTION OF THE EMBODIMENTS

According to a preferred exemplary embodiment of the present disclosure, an image processing apparatus includes an acquisition unit configured to acquire first shape information representing a three-dimensional shape of a subject generated based on a plurality of captured images at a first imaging time. The acquisition unit is also configured to acquire second shape information representing a three-dimensional shape of the subject generated based on a plurality of captured images at a second imaging time. The image processing apparatus further includes a generation unit configured to generate first distance information indicating a distance from a first position in a virtual space to the three-dimensional shape corresponding to the first shape information based on the first shape information. The generation unit is also configured to generate second distance information indicating a distance from a second position in the virtual space to the three-dimensional shape corresponding to the second shape information based on the second shape information. The image processing apparatus further includes a setting unit configured to set a first tracking point of the three-dimensional shape corresponding to the first shape information at the first imaging time based on the first distance information. The setting unit is also configured to set a second tracking point of the three-dimensional shape corresponding to the second shape information at the second imaging time based on the second distance information. Then, in a case where a distance between a position of the first tracking point and a position of the second tracking point is less than or equal to a predetermined value, the setting unit sets the same identifier for the first tracking point as an identifier set for the second tracking point. The identifier herein refers to an identifier representing a subject and may be, for example, an identifier (ID) assigned to each subject or a name of the subject. Further, the identifier representing the subject may be acquired from statistical information. Further, each of the first shape information and the second shape information stores the three-dimensional coordinates of a plurality of components constituting the three-dimensional shape. Further, the position of the first tracking point and the position of the second tracking point refer to three-dimensional coordinates in the virtual space. Specifically, each of the positions refers to a set of coordinates along the X-axis, Y-axis, and Z-axis of the coordinate system in the virtual space. Further, the first position and the second position refer to three-dimensional coordinates in the virtual space. Thus, the first position may be referred to as a predetermined point, or the second position may be referred to as a predetermined point.

This configuration facilitates subject tracking in various imaging environments. A subject can be tracked easily even in an imaging environment where the height of the subject varies significantly depending on the situation, such as in keirin. A subject can also be tracked easily even in a case where an individual is rotating with their head positioned downward during capturing of a movie using wire work, i.e., a case where the posture of the subject varies significantly.

Further, the first distance information indicates a distance from the first position to a plurality of first components constituting the three-dimensional shape corresponding to the first shape information. For example, in a case where the three-dimensional shape is represented as point cloud data composed of a plurality of points, each first component is a point. In a case where the three-dimensional shape is represented as a mesh model, each first component is a respective polygon that constitutes the mesh model. In a case where the three-dimensional shape is represented by voxels, each first component is a voxel. It should be noted that the first distance information may be generated by placing a virtual camera at the first position, determining an orientation of the virtual camera so that the virtual camera faces the three-dimensional shape, and generating a distance image. In this case, each pixel of the distance image stores distance information from the virtual camera to the first component corresponding to the pixel. It should be noted that each pixel stores distance information to the corresponding component constituting a surface of the three-dimensional shape as viewed from the virtual camera. Further, the orientation of the virtual camera is defined by pan, tilt, and roll. Further, the second distance information indicates a distance from the second position to a plurality of second components constituting the three-dimensional shape corresponding to the second shape information.

Further, the first tracking point is a first component with the shortest or greatest distance among the plurality of first components. Further, the second tracking point is a second component with the shortest or greatest distance among the plurality of second components. It should be noted that whether the component with the shortest distance or the component with the greatest distance is to be set as the first tracking point is determined based on the relative position of the first position with respect to the three-dimensional shape. In a case where the first position is set at a lower position with respect to the three-dimensional shape in the virtual space, the component with the greatest distance is set as the first tracking point. For example, in the case of imaging keirin, if the first position is set at a position in the virtual space corresponding to an underground position in the real world, which is a position lower than a three-dimensional shape representing an athlete, the component with the greatest distance is a component constituting the head or back of the athlete. It should be noted that in a case where the first position is set at a higher position with respect to the three-dimensional shape, the component with the shortest distance is set as the first tracking point.

It should be noted that the component with the greatest distance may be set as the first tracking point in the case where the first position is set at a higher position with respect to the three-dimensional shape, and the component with the shortest distance may be set as the first tracking point in the case where the first position is set at a lower position with respect to the three-dimensional shape. The combination of the relative positional relationship between the three-dimensional shape and the first position, and whether the greatest or smallest distance is to be used, may be preset based on the imaging target. Alternatively, it may be set by an operator at the start of imaging. It should be noted that the determination of whether the component with the shortest distance or the component with the greatest distance is to be set as the second tracking point is similar to that for the first tracking point, so that description thereof will be omitted.

This configuration facilitates tracking of a subject having a complex shape. For example, in keirin, bicycles have slender shapes, and stable generation of a three-dimensional shape may not always be achieved. In such a case, a configuration may be employed that enables tracking based on distance information of components constituting a three-dimensional shape of an athlete riding a bicycle, instead of the bicycle itself.

Further, the first tracking point may be a first component included within a predetermined region among the plurality of first components. For example, a region corresponding to a foreground may be detected from the distance image, and a component included within the detected region may be set as the first tracking point. It should be noted that the region corresponding to the foreground is determined based on a distance value. Similarly, the second tracking point may be a second component included within a predetermined region among the plurality of second components.

Further, the plurality of first components and the plurality of second components may be classified into a plurality of regions, and the first tracking point and the second tracking point may be set for each of the plurality of regions.

This configuration enables automatic setting of the plurality of first tracking points and the plurality of second tracking points based on the distance information.

Further, the setting unit collectively sets the plurality of first tracking points included within a predetermined range as a single first tracking point. Specifically, the setting unit collectively sets the plurality of first tracking points as a single first tracking point at a centroid position of the plurality of first tracking points included within the predetermined range. It should be noted that the predetermined range is a range centered on the first tracking point. It should be noted that the predetermined range differs for each imaging target. For example, when the imaging target is keirin, and predetermined range is set along a track course of a keirin velodrome. The movement direction of an athlete can be estimated based on the track course of the keirin velodrome. Accordingly, the predetermined range may be determined based on the position of the athlete within the track course of the keirin velodrome. Specifically, an ellipse having its major axis along the travel direction of the athlete is set as the predetermined range. Further, the lengths of the major and minor axes are set to encompass one athlete. Setting the first position above the three-dimensional shape enables generation of a distance image viewed from an overhead perspective of the three-dimensional shape. In the overhead image, a predetermined range encompassing the athlete may be set in advance for each imaging target. For example, in a case where the imaging target is keirin, since the athlete competes in a forward-leaning posture, an ellipse is set as the predetermined range in the overhead image. It should be noted that the plurality of second tracking points may be collectively set as a single second tracking point, as in the above-described method in which the plurality of first tracking points is collectively set as a single first tracking point.

Further, the shape information represents a three-dimensional shape of a plurality of subjects, and the setting unit sets the same number of first tracking points as the number of the plurality of subjects.

This configuration enables subject tracking even in a case where the plurality of subjects is in contact with one another or is present in close proximity. For example, in a case where a plurality of subjects is holding hands, a single three-dimensional shape is generated. With this three-dimensional shape information alone, it is difficult to determine whether a plurality of subjects is present. Accordingly, the plurality of first tracking points is set for each of the plurality of divided regions, thereby allowing a first tracking point to be set for each of a plurality of subjects even in a case where the plurality of subjects is present within the three-dimensional shape. It should be noted that simply setting a first tracking point for each of a plurality of divided regions may result in a plurality of first tracking points being set for a three-dimensional shape representing a single subject, depending on how the regions are set. Therefore, the plurality of first tracking points included within the predetermined range is collectively set as a single tracking point, thereby allowing one tracking point to be set for each subject.

Further, the first position is generated based on a bounding box enclosing the three-dimensional shape. It should be noted that the method for setting the bounding box enclosing the three-dimensional shape is not particularly limited. A trained model may be provided that inputs a plurality of three-dimensional shapes representing a plurality of subjects and outputs a bounding box enclosing each three-dimensional shape. Alternatively, in a virtual space including a plurality of three-dimensional shapes, the virtual space is divided into a plurality of regions, and it is determined whether each region includes a three-dimensional shape. The initial division is performed using large regions, and determinations are made using progressively smaller regions, i.e., classification is performed using an octree, thereby enabling the setting of a plurality of bounding boxes respectively enclosing the plurality of three-dimensional shapes.

The first position is set at a position at a predetermined distance from a center of an upper surface of the bounding box.

This configuration enables the generation of distance information for each of the plurality of three-dimensional shapes.

It should be noted that the first position may be set based on a three-dimensional shape representing a background specified based on the position of the three-dimensional shape. For example, in a case where the three-dimensional shape representing the background is a three-dimensional shape representing a keirin velodrome, the line-of-sight direction of the virtual camera corresponding to the first position is set to a direction perpendicular to the track course of the keirin velodrome. As a result, the distance information indicates a distance from the first position to the three-dimensional shape in a direction perpendicular to the track course of the keirin velodrome where the three-dimensional shape is positioned.

This configuration reduces the risk that, in a case where a plurality of subjects is present, the plurality of subjects overlaps in the three-dimensional shape captured from the first position and accurate distance information may not be obtained. In other words, in a case where a plurality of subjects are present, the stability of tracking the plurality of subjects can be improved. Further, the configuration allows for application in imaging across various venues. For example, in a case where the line-of-sight direction of the virtual camera corresponding to the first position is oriented toward the Z-axis direction in the virtual space and the stadium includes a slope, a plurality of athletes may overlap when viewed from the first position. In this case, setting the first position appropriately for the venue reduces the risk that the plurality of subjects may overlap and inaccurate distance information may be acquired.

Further, the image processing apparatus includes an output unit configured to output position information indicating the position of the first tracking point and identifier information. For example, the position information and the identifier information may be output in association with each other to an external recording medium.

This configuration enables the tracking results to be utilized in other apparatuses. The tracking results can be utilized for various purposes, such as displaying the trajectory of the tracking target or analyzing its movement trends.

According to another exemplary embodiment of the present exemplary embodiment, an image processing method includes acquiring first shape information representing a three-dimensional shape of a subject generated based on a plurality of captured images at a first imaging time. Further, second shape information representing a three-dimensional shape of the subject generated based on a plurality of captured images at a second imaging time is also acquired. Further, the image processing method also includes generating first distance information indicating a distance from a first position in a virtual space to the three-dimensional shape corresponding to the first shape information based on the first shape information and generates second distance information indicating a distance from a second position in the virtual space to the three-dimensional shape corresponding to the second shape information based on the second shape information. Further, the image processing method includes setting a first tracking point of the three-dimensional shape corresponding to the first shape information at the first imaging time based on the first distance information and also sets a second tracking point of the three-dimensional shape corresponding to the second shape information at the second imaging time based on the second distance information. Then, in a case where a distance between a position of the first tracking point and a position of the second tracking point is less than or equal to a predetermined value, the same identifier is set for the first tracking point as an identifier set for the second tracking point.

According to yet another preferred exemplary embodiment of the present exemplary embodiment, a program causes a computer to perform the above-described image processing method. By executing the program the computer suitably functions as the image processing apparatus described above.

In the present exemplary embodiment, a distance image from a predetermined point in a three-dimensional space is generated for each three-dimensional shape, and a tracking point for use in subject tracking is set using the distance image, thereby facilitating subject tracking. For example, a virtual camera is installed perpendicular to the upper surface of the bounding box enclosing the three-dimensional shape, and a distance image indicating the distance from the virtual camera to the three-dimensional shape is generated. Then, the distance image is divided into predetermined regions, and a local minimum point of the distance is extracted from each predetermined region. A process of consolidating the plurality of extracted local minimum points included within a predetermined range is performed, and a tracking point is set.

An image processing system is a system configured to generate a virtual viewpoint image representing a scene from a specified virtual viewpoint based on a plurality of images captured by a plurality of imaging apparatuses and the specified virtual viewpoint. In the present exemplary embodiment, the virtual viewpoint image, also referred to as free-viewpoint video, is not limited to an image corresponding to a viewpoint freely (or arbitrarily) specified by the user. For example, an image corresponding to a viewpoint selected by the user from a plurality of candidates is also included in the virtual viewpoint image. Further, although the present exemplary embodiment mainly describes a case where a virtual viewpoint is specified by a user operation, a virtual viewpoint may be automatically specified based on the results of an image analysis. Further, although the present exemplary embodiment mainly describes a case where the virtual viewpoint image is a moving image, the virtual viewpoint image may be a still image.

Viewpoint information used in virtual viewpoint image generation indicates the position and orientation (line-of-sight direction) of the virtual viewpoint. Specifically, the viewpoint information is a parameter set including a parameter representing the three-dimensional position of the virtual viewpoint and a parameter representing the orientation of the virtual viewpoint in the pan, tilt, and roll directions. It should be noted that the content of the viewpoint information is not limited to those described above. For example, the parameter set as the viewpoint information may include a parameter representing the field of view (angle of view) of the virtual viewpoint. Further, the viewpoint information may include a plurality of parameter sets. For example, the viewpoint information may include a plurality of parameter sets respectively corresponding to a plurality of frames constituting the video of the virtual viewpoint image and indicates the position and orientation of the virtual viewpoint at each of a plurality of consecutive time points.

The image processing system includes a plurality of imaging apparatuses configured to capture an image of an image capturing region from a plurality of directions. The image capturing region is, for example, a stadium where competitions such as soccer or karate are held, or a stage where concerts or theatrical performances take place. The plurality of imaging apparatuses is installed at different positions to surround the image capturing region and performs synchronized image capturing. It should be noted that the plurality of imaging apparatuses does not necessarily have to be installed around the entire circumference of the image capturing region, and depending on constraints such as the installation locations, the plurality of imaging apparatuses may be installed only in a part of the surrounding area of the image capturing region. Further, the number of imaging apparatuses is not limited to the illustrated example. For example, in a case where a soccer stadium is set as an image capturing region, approximately 30 imaging apparatuses may be installed around the stadium. Further, imaging apparatuses with different functions such as telephoto and wide-angle cameras may be installed.

It should be noted that each of the plurality of imaging apparatuses according to the present exemplary embodiment is a camera that has an independent housing and is capable of capturing an image from a single viewpoint. However, this is not intended to be limiting, and two or more imaging apparatuses may be included within the same housing. For example, a single camera that includes a plurality of lens units and a plurality of sensors and is capable of capturing an image from a plurality of viewpoints may be installed as the plurality of imaging apparatuses.

The virtual viewpoint image is generated using the following method. First, the plurality of imaging apparatuses perform image capturing from different directions, thereby acquiring a plurality of images (a plurality of viewpoint images). Next, a foreground image is acquired by extracting a foreground region corresponding to a predetermined object, such as a person or ball, from the plurality of viewpoint images, and a background image is acquired by extracting a background region other than the foreground region from the plurality of viewpoint images. Further, a foreground model representing a three-dimensional shape of the predetermined object and texture data for applying color to the foreground model are generated based on the foreground image, and texture data for applying color to a background model representing a three-dimensional shape of the background, such as a stadium, is generated based on the background image. Then, a virtual viewpoint image is generated by mapping the texture data onto the foreground and background models and performing rendering based on the virtual viewpoint specified by the viewpoint information. However, the virtual viewpoint image generation method is not limited to the foregoing method, and various other methods may also be used, such as a method of generating a virtual viewpoint image by performing a projective transformation of a captured image without using a three-dimensional model.

The foreground image refers to an image acquired by extracting an object region (foreground region) from an image captured by the imaging apparatus. The object extracted as the foreground region refers to a dynamic object (moving body) that exhibits motion (that may change in absolute position or shape) in a case where image capturing is performed over time from the same direction. The object in a competition is, for example, a person such as an athlete or referee present within a field where the competition takes place. In a ball game, the object is, for example, a ball. In a concert or entertainment setting, the object is, for example, a singer, an instrumentalist, a performer, or a presenter.

The background image refers to an image of a region (background region) that at least differs from the object that constitutes the foreground. Specifically, the background image is an image obtained after the object that constitutes the foreground has been removed from the captured image. Further, the background refers to an imaging target that remains stationary or nearly stationary in a case where image capturing is performed from the same direction over time. Examples of such imaging targets include a concert stage, a stadium where an event such as a competition is held, a structure such as a goal used in a ball game, and a field. However, the background may be a region that at least differs from the object that constitutes the foreground, and the imaging target may include another object in addition to the object and the background.

The virtual camera refers to a virtual camera that is distinct from the plurality of imaging apparatuses physically installed around the image capturing region and is a concept used to conveniently describe the virtual viewpoint related to the virtual viewpoint image generation. In other words, the virtual viewpoint image can be considered as an image captured from a virtual viewpoint set within the virtual space associated with the image capturing region. Furthermore, the position and orientation of the virtual viewpoint during image capturing can be represented as the position and orientation of the virtual camera. In other words, assuming that a camera is present at the position of the virtual viewpoint set within the space, the virtual viewpoint image may be regarded as an image that simulates an image captured by the camera. Further, the temporal progression of the virtual viewpoint is referred to as a virtual camera path in the present exemplary embodiment. However, the use of the virtual camera concept is not essential for implementing the configuration of the present exemplary embodiment. In other words, it is sufficient to set at least information indicating a specific position within the space and information indicating an orientation and to generate a virtual viewpoint image based on the set information.

### Configuration and Operation Related to Virtual Viewpoint Image Generation

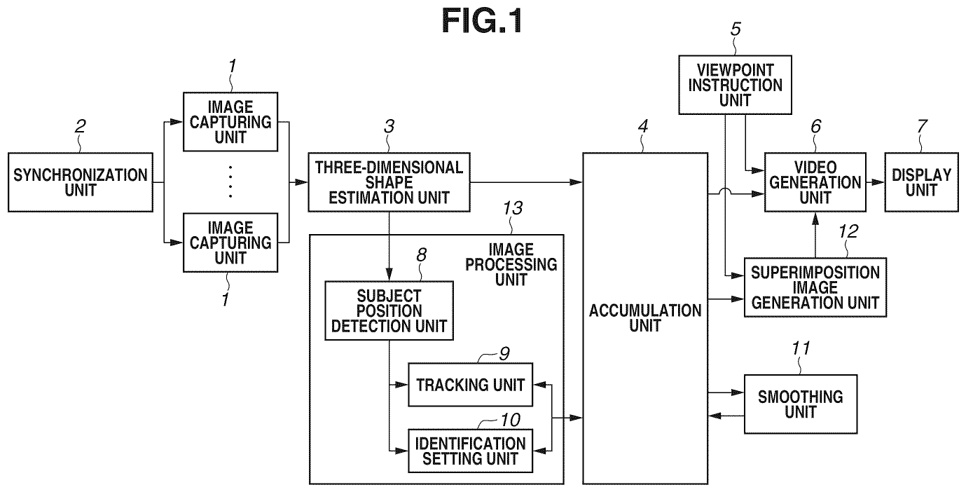

FIG. 1 illustrates an example of a configuration of an image processing system configured to generate a virtual viewpoint image according to an exemplary embodiment. The image processing system includes an image capturing unit 1, a synchronization unit 2, a three-dimensional shape estimation unit 3, an accumulation unit 4, a viewpoint instruction unit 5, a video generation unit 6, a display unit 7, a smoothing unit 11, a superimposition image generation unit 12, and an image processing unit 13. The image processing unit 13 includes a subject position detection unit 8, a tracking unit 9, and an identification setting unit 10. It should be noted that the image processing unit 13 may include the smoothing unit 11. It should be noted that the image processing system may include a single image processing apparatus or a plurality of image processing apparatuses. In the following description, the image processing unit 13 is regarded as a single image processing apparatus, and the other components are described as being configured individually as separate devices.

The plurality of image capturing units 1 captures images in synchronization with each other based on a synchronization signal from the synchronization unit 2. The plurality of image capturing units 1 outputs the captured images to the three-dimensional shape estimation unit 3. It should be noted that the plurality of image capturing units 1 is arranged to surround an imaging region including a subject so that the subject can be captured from a plurality of directions.

The synchronization unit 2 outputs the synchronization signal to the plurality of image capturing units 1.

The three-dimensional shape estimation unit 3 generates, for example, a silhouette image of the subject using the plurality of input captured images and then generates a three-dimensional shape of the subject using a visual hull method.

Further, the three-dimensional shape estimation unit 3 outputs the generated three-dimensional shape of the subject, the captured images of the subject, and the imaging time of the captured images in association with one another to the accumulation unit 4. Specifically, a three-dimensional shape of the subject is generated for each imaging time, and the generated three-dimensional shape of the subject is output to the accumulation unit 4 in association with the captured images and the imaging time. It should be noted that the form of association is not limited and, for example, a single file may include information representing the three-dimensional shape of the subject, the captured images, and the imaging time. Alternatively, a file that is assigned a file name including the imaging time and includes information representing the three-dimensional shape of the subject and another file that is assigned a file name including the imaging time and includes the captured images may be output to the accumulation unit 4. As used herein, the subject refers to an object that is the target of three-dimensional shape generation, and may include a person or an item managed by a person.

The accumulation unit 4 stores and accumulates the following data sets as data (material data) for use in virtual viewpoint image generation. Data for use in virtual viewpoint image generation includes, specifically, the three-dimensional shape of the subject, the captured images of the subject, and the imaging time of the captured images input from the three-dimensional shape estimation unit 3. Further, data for use in virtual viewpoint image generation includes camera parameters such as positions, orientations, and optical properties of the image capturing units. It should be noted that a background model and a background texture image are stored (recorded) in advance in the accumulation unit 4 as data for use in virtual viewpoint image generation. Further, tracking information and subject identification information are respectively acquired from the tracking unit 9 and the identification setting unit 10 and recorded. Further, information representing a combination of a tracking identifier and a subject identifier acquired from the smoothing unit 11 is recorded.

The viewpoint instruction unit 5 includes a viewpoint operation unit and a display unit. The viewpoint operation unit is a physical user interface (not illustrated), such as a joystick or jog dial, and the display unit is configured to display a virtual viewpoint image.

The virtual viewpoint of the displayed virtual viewpoint image can be changed using the viewpoint operation unit.

As the virtual viewpoint is changed by the viewpoint operation unit, a virtual viewpoint image is generated in real time by the video generation unit 6, which will be described below, and displayed on the display unit. The display unit 7, which will be described below, may also be used as the display unit, or another display device may be included as the display unit. The viewpoint instruction unit 5 generates virtual viewpoint information based on the input from the viewpoint operation unit and outputs the generated virtual viewpoint information to the video generation unit 6. The virtual viewpoint information includes information corresponding to external camera parameters, such as virtual viewpoint position and orientation, information corresponding to internal camera parameters, such as focal length and angle of view, and time information representing the imaging time of captured images for use in virtual viewpoint image generation.

The video generation unit 6 acquires material data corresponding to the imaging time from the accumulation unit 4 based on the time information included in the input virtual viewpoint information. The video generation unit 6 generates a virtual viewpoint image from a specified virtual viewpoint using the three-dimensional shape and captured images of the subject from the acquired material data, and outputs the generated virtual viewpoint image to the display unit 7.

The display unit 7 is a display unit configured to display a video input from the video generation unit 6. The display unit 7 includes a display.

The subject position detection unit 8 acquires the generated three-dimensional shape from the three-dimensional shape estimation unit 3. In a case where a plurality of subjects is imaged, a single three-dimensional shape may include a plurality of subjects. For example, in a case where a plurality of subjects is in contact with one another, a single three-dimensional shape is generated. Thus, in a case where a single three-dimensional shape includes a plurality of subjects, the subject position detection unit 8 separates the plurality of subjects and sets a detection point (tracking point) for each of the plurality of subjects. This detection point is a point representing three-dimensional coordinates in a virtual space. It should be noted that in a case where a single three-dimensional shape includes a single subject, a single detection point is set. A specific process will be described below. The set detection point is output to the tracking unit 9.

The tracking unit 9 assigns an individual tracking identifier to each detection point acquired from the subject position detection unit 8. In a case where a detection point is acquired for the first time after the start of imaging, an individual tracking identifier is assigned to the detection point. The method of assignment is not particularly limited. For example, tracking identifiers may be assigned to detection points at random or in an order based on the proximity of the positions of the detection points to an origin of the virtual space. In a case where a plurality of detection points is acquired, a different tracking identifier is assigned to each detection point. For example, in a case where detection points A and B are acquired, tracking identifiers A and B are assigned, respectively. For each detection point acquired thereafter, the position of the detection point corresponding to the imaging time (the imaging time of the processing target) of the acquired three-dimensional shape is compared with that of a detection point corresponding to a previous imaging time. In a case where the position of the detection point corresponding to the previous imaging time is within a predetermined range from the position of the detection point corresponding to the imaging time of the processing target, the detection points are determined to correspond to the same subject. Then, a tracking identifier associated with the detection point corresponding to the previous imaging time is acquired and assigned to the detection point corresponding to the imaging time of the processing target. In other words, the same tracking identifier as that of the detection point corresponding to the previous imaging time within the predetermined range is assigned to the position of the detection point corresponding to the imaging time of the processing target. By repeating the above-described process in the order of imaging time, the tracking unit 9 generates information associating position information about a detection point with a tracking identifier of the detection point for each imaging time. This information represents a combination of position information about a detection point and a tracking identifier of the detection point for each imaging time. Then, the information associating position information about a detection point with a tracking identifier of the detection point is output as tracking information to the accumulation unit 4. The tracking information is used to acquire position information about a detection point based on the imaging time and the tracking identifier assigned to the target subject for tracking.

The identification setting unit 10 assigns an individual subject identifier to a detection point acquired from the subject position detection unit 8. The method for generating a subject identifier is not particularly limited. For example, subject identification information may be generated using a captured image accumulated in the accumulation unit 4. Specifically, the position of each detection point detected by the subject position detection unit 8 is projected onto images captured by the plurality of imaging apparatuses based on the internal and external parameters of the plurality of imaging apparatuses. This projection enables identification of pixels corresponding to the detection point in the captured images. Then, color information in the vicinity of the identified pixels is acquired. The reason for acquiring color information in the vicinity of the identified pixels is to consider the risk of an erroneous determination in subject identification in subsequent processing in a case where the captured images contain noise. At this time, color information outside the silhouette of the subject is not acquired. For example, in keirin, since the uniform of each subject (athlete) differs in color, a subject identifier is generated in advance for each color.

Subject identification information associating a subject identifier is generated, such as associating a red uniform with an athlete A and a blue uniform with an athlete B. In generating the subject identifier in advance, statistical information may be used, for example. Then, a subject identifier corresponding to the detection point is determined and assigned based on the generated subject identification information and the color information acquired from the captured images. It should be noted that information such as hue, saturation, and/or luminance may also be used in addition to the color information. It should be noted that in a case where a plurality of subjects is present during the acquisition of color information from the captured images by the identification setting unit 10, occlusion may occur due to the plurality of subjects. Thus, a subject identifier may be assigned to the detection point after acquiring color information from the plurality of captured images, conducting a majority determination, and excluding color information that clearly deviates. The identification setting unit 10 outputs information associating the position information about the detection point with the subject identifier as subject identification information to the accumulation unit 4.

It is not necessary to perform the process of generating subject identification information for every imaging time, as it imposes a high processing load. For example, the process may be performed once every few seconds. Alternatively, the process may be performed in a case where a condition is satisfied, depending on the method for assigning a subject identifier. For example, a subject identifier may be assigned using the position information about the detection point.

Specifically, in the case of imaging a baseball game, the position of each player immediately before a pitcher throws a ball is roughly fixed according to their assigned position. Thus, a predetermined region is set for each assigned position, and a subject identifier is assigned while a detection point is positioned within the predetermined region. It should be noted that since information about each player participating at the imaging time and the position assigned to the participating player can be extracted from the statistical information, a detection point positioned within the predetermined region corresponding to the assigned position can be determined as the participating player. This facilitates the assignment of the subject identifier to the participating player.

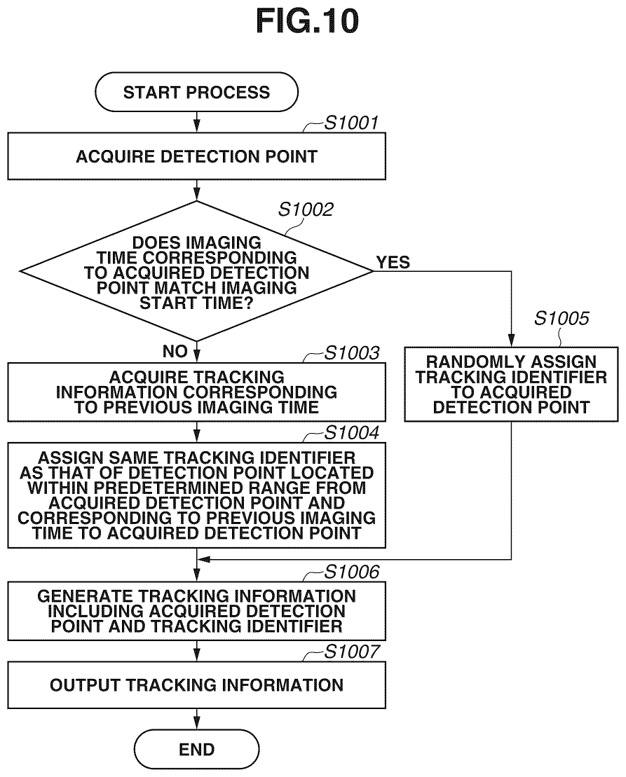

The smoothing unit 11 acquires the tracking information and subject identification information recorded in the accumulation unit 4 and generates a mapping table presenting a correspondence between the tracking identifiers assigned to tracking information and the subject identifiers. It should be noted that subject identification information may not be present in the accumulation unit 4 at certain imaging times in a case where the identification setting unit 10 assigns an identifier once every few seconds or accurate subject identification is hindered due to the superimposition of a plurality of subjects. Thus, the smoothing unit 11 identifies a combination of a tracking identifier and a subject identifier for each imaging time based on the mapping table presenting the correspondence between the tracking identifiers and the subject identifiers. Details thereof will be described below with reference to FIG. 10.

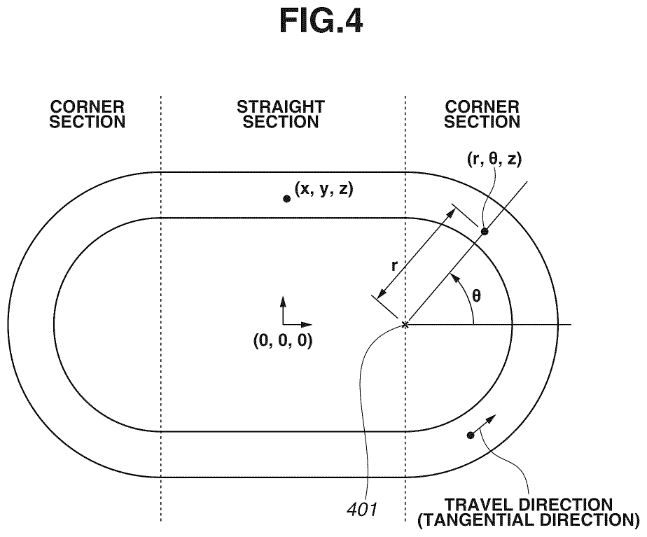

Furthermore, the smoothing unit 11 performs a process for smoothed position information included in tracking information. The smoothing process is performed for the following reason. Since the positions of the detection points detected by the subject position detection unit 8 may contain an error due to the orientation of the subject and/or the accuracy of shape estimation, the resulting information may contain fine fluctuations and be unsuitable for use in virtual viewpoint operations or in trajectory and velocity information calculations. Therefore, the smoothing process is performed. A smoothing process specialized for track-based sports will be described herein. Specifically, as illustrated in FIG. 4, the smoothing process is performed separately for corner sections and straight sections. First, for the straight sections, processing such as low-pass filtering or moving averaging is performed in a time direction for each of X-, Y-, and Z-axis values in an orthogonal coordinate system defined by the X-, Y-, and Z-axes, thereby generating smoothed position information with suppressed high-frequency components. For the corner sections, first, the orthogonal coordinate system defined by the X-, Y-, and Z-axes is transformed into a cylindrical coordinate system with its origin at a center portion 401 of a corner as illustrated in FIG. 4. Thereafter, as with the straight sections, smoothing is performed in the time direction for each of the values of radius r, angle θ, and height z, and position information about the smoothed cylindrical coordinates is re-transformed into the orthogonal coordinate system defined by the X-, Y-, and Z-axes. The corner sections are smoothed after being transformed into the cylindrical coordinates because performing smoothing in the orthogonal coordinate system may cause the output result to shift inward at corners, resulting in inaccurate smoothing results. The smoothing unit 11 includes a velocity calculation unit, and after smoothing the position information, the smoothing unit 11 also calculates velocity information from the smoothed position information. The smoothing unit 11 records, for each imaging time, smoothed position information, velocity information, and subject identification information in association with one another in the accumulation unit 4.

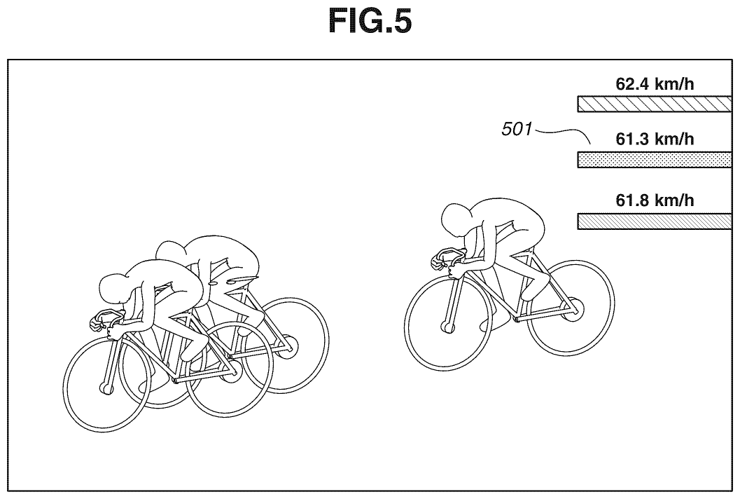

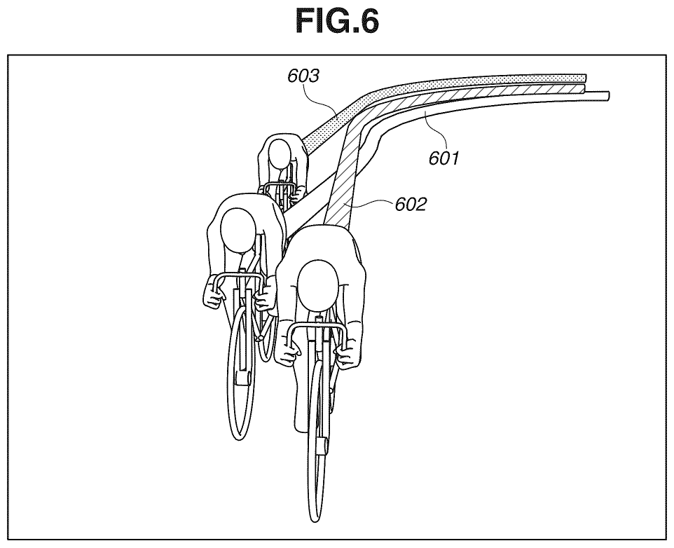

The superimposition image generation unit 12 acquires the smoothed position information, velocity information, and subject identification information recorded in the accumulation unit 4 and generates a superimposition image. The superimposition image refers to, for example, a superimposition image (velocity display image 501) displaying a velocity for each athlete as illustrated in FIG. 5. The velocity display image 501 is generated by acquiring, from the accumulation unit 4 for each athlete, velocity information corresponding to the time information input from the viewpoint instruction unit 5 and rendering the corresponding numerical values. Alternatively, trajectories 601 to 603 illustrating how each athlete navigated a course are rendered by plotting the smoothed position information for each time point or connecting them with lines on a virtual viewpoint image as illustrated in FIG. 6.

### Subject Position Tracking Method

Next, a subject position tracking method according to the present exemplary embodiment will be described with reference to keirin as an example. A corner section of a keirin track course has a slope referred to as banking, and a height difference of three meters or more exists between inner and outer edges of the track course. The present disclosure is also applicable to such an imaging environment in which a heigh difference exists within an imaging target region.

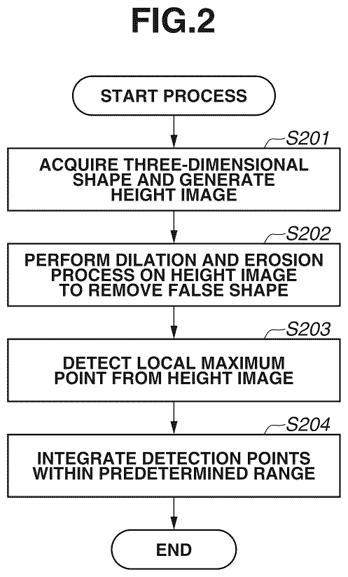

The subject position tracking method includes a process of detecting a detection point of a subject, a process of setting a tracking identifier based on a detection point from a previous imaging time, and a process of setting a subject identifier representing which subject corresponds to the set tracking identifier. The processes will be described with reference to FIGS. 2, 10, 11, and 12.

FIG. 2 is a flowchart illustrating a process of setting a detection point of a subject by the subject position detection unit 8. This process is intended to be performed for each imaging time corresponding to a captured image corresponding to a three-dimensional shape. In other words, the process is performed for each three-dimensional shape corresponding to a set of images captured in synchronization. Further, the plurality of image capturing units 1 may capture a plurality of video images in synchronization and generate a three-dimensional shape representing a series of movements based on the plurality of video images. Accordingly, the process may be regarded as being performed for each frame of the captured moving image.

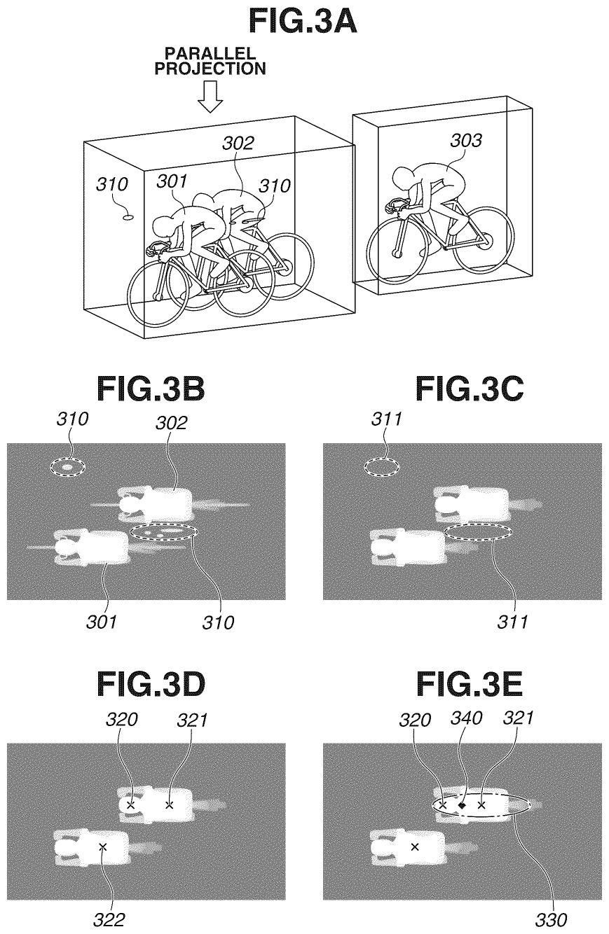

In step S201, a three-dimensional shape is acquired from a three-dimensional shape estimation unit 3, and a height image corresponding to the three-dimensional shape is generated. As illustrated in FIG. 3A, a plurality of three-dimensional shapes (subjects 301 to 303) is acquired. At this time, information representing a region (bounding box) enclosing the three-dimensional shapes is acquired. It should be noted that instead of acquiring a region enclosing the three-dimensional shapes, the subject position detection unit 8 may specify a region enclosing the three-dimensional shapes. It should be noted that a method for setting a region enclosing the three-dimensional shapes may employ spatial partitioning using an octree. Since this is a publicly known technology, detailed descriptions thereof are omitted herein. A height image (FIG. 3B) is generation by performing a parallel projection from directly above the region enclosing the three-dimensional shapes. Specifically, a distance image is generated by calculating the distance from the lower plane of the bounding box enclosing the three-dimensional shapes to each component of the three-dimensional shapes. It should be noted that in a case where a plurality of components corresponds to the same pixel, the component with a greater distance value is associated with the pixel, thereby generating a distance image indicating the distance to the component of the three-dimensional shape farthest from the lower plane. Therefore, the distance image corresponds to the height image. To display the height image as an image recognizable by an operator, the image is generated so that higher regions appear brighter, lower regions appear darker, and regions not containing the three-dimensional shapes are assigned a value of zero. It should be noted that the height image contains distance information at each pixel and does not necessarily need to be displayed as a visually identifiable image. The size of the image may be determined based on the circumscribed rectangle of the three-dimensional shapes to be detected. In this case, since the subjects 301 and 302 are in close proximity, it is assumed that the subjects 301 and 302 have been estimated as a single three-dimensional shape in the shape estimation. As described above, the height image is a distance image in which distance information from a predetermined point in a virtual space to the three-dimensional shape is represented. Further, it may also be regarded as information representing a height from a floor surface. It should be noted that height image is not intended to be limiting. Alternatively, a virtual camera may be set at a position at a predetermined distance in a direction perpendicular to an upper surface of the bounding box from a center of the upper surface, and a distance image from the virtual camera to the three-dimensional shapes may be generated. The following process is performed for each region enclosing the three-dimensional shapes.

In step S202, a process for removing a false shape 310, which may be caused by occlusion during imaging or by an extraction error of the subjects, is performed on the height image. The false shape 310 is, for example, noise referred to as floating debris generated by sand or dust captured as a three-dimensional shape or a three-dimensional shape generated due to an extraction error of the subjects. As a specific process, the floating shape is removed (311 in FIG. 3C) by performing an erosion process for a predetermined number of pixels on pixels having non-zero values in the image in FIG. 3B, followed by a dilation process for a predetermined number of pixels. In the present exemplary embodiment, this process is referred to as a dilation and erosion process. It should be noted that the process for removing the false shape 310 is not intended to be limiting, and any publicly known technique may be used. Since techniques for removing a false shape or noise from a captured image are publicly known, descriptions of other processing methods are omitted herein.

In step S203, a point having the maximum height (a point at which a local maximum occurs) within a predetermined region in the height image is detected (identified) as a detection point. Specifically, a point having the maximum height within a region of approximately 20 cm square is detected. Accordingly, the top of the head of each subject can be identified even in a case where a plurality of persons is walking while holding hands. In bicycle racing, since the athletes adopt a forward-leaning posture, the heads or backs of the athletes may be detected as detection points 320 to 322 (FIG. 3D). It should be noted that the predetermined region is set by dividing the height image into a plurality of regions. Furthermore, the shape and size of the predetermined region may be set for each imaging target.

In step S204, the plurality of detection points are integrated. This process is performed because in a case where a plurality of regions is set in step S203, the plurality of detection points 320 and 321 may be detected for a single subject. In a case where a plurality of detection points are detected, the plurality of detection points are individually classified into a plurality of regions. In order to set one detection point for each subject, the plurality of detection points is integrated to set a single representative detection point. Specifically, it is determined whether another detection point exists within a predetermined range centered on the detected detection point 321, as illustrated in FIG. 3E. For example, in the case of imaging keirin, a search is performed to determine whether another detection point exists within an approximately 70-cm range in the travel direction (whether another detection point exists within a dashed line 330 in FIG. 3E), and in a case where the predetermined range includes another detection point, this detection point is integrated. The size of the predetermined range is set to 70 cm for the following reason. In keirin, since each subject (athlete) adopts a forward-leaning posture as illustrated in FIG. 3A, the head and back may be detected as detection points. Thus, 70 cm is set as a distance that approximately encompasses the head and back. In this case, the detection point 320 corresponds, and, for example, a midpoint 340 (centroid position) between the detection points 320 and 321 is used as the integrated detection point. The travel direction herein will be described below. Since there are no pixels with a pixel value of 0 between the detection points 320 and 321, the detection points 320 and 321 are treated as detection points of the same subject and integrated. Although the present exemplary embodiment assumes that no other detection points are included within the predetermined range centered on the detection point 322, inclusion of another detection point may occur depending on how the predetermined range is set. In this case, one detection point is set for two subjects, making accurate tracking of the subjects difficult. Thus, in a case where another detection point exists within the predetermined range centered on a detection point and a region having a pixel value of 0 is present along a straight line connecting the detection point and the other detection point existing within the predetermined range, it may be determined that the three-dimensional shapes are not connected, and no integration of the detection points may be performed. For example, since a region having a pixel value of 0 is present between the detection points 320 and 321, the detection point 322 is treated as a detection point of a subject different from the subject from which the detection points 320 and 321 have been detected, and no integration of the detection point is performed.

Through steps S201 to S204, the subject position detection unit 8 detects one detection point for each subject. By performing the above-described process for each imaging time of the captured images corresponding to the three-dimensional shapes, a detection point is detected for each imaging time. This detection point represents three-dimensional position information along the X-, Y-, and Z-axes, and this it output to the tracking unit 9 and the identification setting unit 10. This enables the tracking unit 9 to generate tracking information and enables the identification setting unit 10 to generate subject identification information.

In the present exemplary embodiment, the travel direction is determined based on spatial positions. Specifically, in track racing, a tangential direction (counterclockwise is generally considered positive) of a track course as illustrated in FIG. 4 is defined as the travel direction. Therefore, the travel direction is determined based on the position of a subject within a stadium. Alternatively, the travel direction may be determined based on the velocity of the subject. Information about the travel direction is recorded in advance in the subject position detection unit 8 in association with the imaging target.

Although the subject position detection unit 8 performs dilation and erosion processing on the height image to remove the false shape 310 in the above-described method, this is not intended to be limiting. For example, a region segmentation process (segmentation) may be performed on effective pixels of the image, and segmented regions having an area less than or equal to a predetermined size (e.g., 1000 pixels or less) may be excluded from the detection targets.

In the above-described method, in a case where a plurality of detection points is detected for the same subject, the plurality of detected detection points is integrated, and a midpoint between the detection points is determined as a new detection point. However, this is not intended to be limiting. For example, an integration method may be employed in which one detection point among a plurality of detection points to be integrated is used while the others are excluded from use. In this case, it is desirable, for the continuity of the data, to use the detection point that was also detected at the previous time.

FIG. 10 is a flowchart illustrating a process for generating tracking information by the tracking unit 9. It should be noted that this process is intended to be performed for each imaging time of the captured images corresponding to the three-dimensional shapes.

In step S1001, the tracking unit 9 acquires a detection point from the subject position detection unit 8.

In step S1002, the tracking unit 9 determines whether the imaging time corresponding to the target detection point for processing matches the imaging start time. The determination method is not particularly limited. The imaging start time may be preset, and it may be determined whether the preset imaging start time corresponds to the imaging time corresponding to the acquired detection point. Alternatively, a variable number N may be set to N=0 at the start of imaging and incremented (N=N+1) after a process of step S1007 described below, thereby counting the number of repetitions of the process illustrated in FIG. 10, and a determination may be made based on the number of repetitions. In a case where the imaging time corresponding to the acquired detection point corresponds to the imaging start time (YES in step S1002), the processing proceeds to step S1005. In a case where the imaging time corresponding to the acquired detection point does not correspond to the imaging start time (NO in step S1002), the processing proceeds to step S1003.

In step S1003, the tracking unit 9 acquires tracking information corresponding to the previous imaging time from the accumulation unit 4. It should be noted that this processing is not intended to be limiting, and the immediately preceding tracking information may be retained.

In step S1004, the tracking unit 9 compares the three-dimensional position of the detection point acquired in step S1001 with the three-dimensional position of the detection point included in the tracking information acquired in step S1003. Then, in a case where the detection point corresponding to the previous imaging time is positioned within a predetermined range from the detection point acquired in step S1001, the same tracking identifier as that of the detection point corresponding to the previous imaging time is assigned to the detection point acquired in step S1001. It should be noted that the predetermined range may be set based on the travel direction, as in the process of integrating the plurality of detection points. Further, the predetermined range is not intended to be limiting, and a tracking identifier of a detection point corresponding to a previous imaging time that is closest to the detection point acquired in step S1001 may be assigned.

In step S1005, the tracking unit 9 randomly assigns a tracking identifier to the detection point acquired in step S1001. In a case where a plurality of detection points is acquired, a different tracking identifier is assigned to each detection point.

In step S1006, the tracking unit 9 generates tracking information including the detection point acquired in step S1001 and the tracking identifier assigned to the detection point.

In step S1007, the tracking unit 9 outputs the tracking information to the accumulation unit 4.

The above-described processing enables the generation of tracking information for each imaging time.

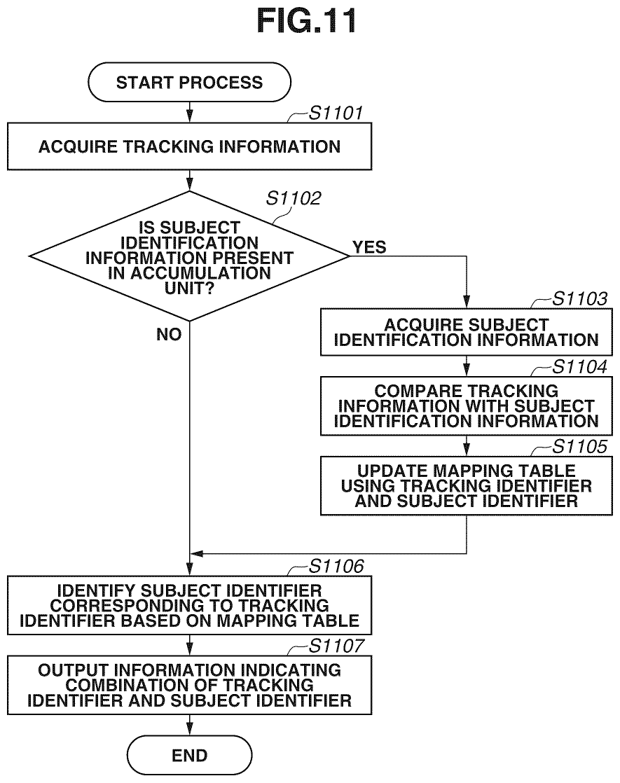

FIG. 11 is a flowchart illustrating a process for associating a tracking identifier with a subject identifier by the smoothing unit 11. It should be noted that this process is intended to be performed sequentially for each imaging time of the captured images corresponding to the three-dimensional shapes. Further, the smoothing unit 11 stores in advance a mapping table indicating combinations of tracking identifiers and subject identifiers. The mapping table can be generated by acquiring tracking identifiers by acquiring tracking information corresponding to the imaging start time. The subject identifiers in the mapping table are updated each time subject identification information is acquired. Then, the subject identifier corresponding to a tracking identifier is identified using the mapping table. The mapping table is used to identify a subject identifier because there may be an imaging time for which subject identification information is unavailable. Even in a case where subject identification information is unavailable for a processing-target imaging time, the subject identifier corresponding to a tracking identifier can still be identified using the mapping table.

In step S1101, the smoothing unit 11 acquires the tracking information from the accumulation unit 4.

In step S1102, the smoothing unit 11 determines whether subject identification information is present in the accumulation unit 4. In a case where subject identification information is present (YES in step S1102), the processing proceeds to step S1103. In a case where subject identification information is absent (NO in step S1102), the processing proceeds to step S1106.

In step S1103, the smoothing unit 11 acquires the subject identification information from the accumulation unit 4. It should be noted that this process may be combined with the process of step S1102 into a single process.

In step S1104, the smoothing unit 11 compares the tracking information acquired in step S1101 with the subject identification information acquired in step S1103. Since the tracking information and the subject identification information include detection points, a pair of a tracking identifier and a subject identifier that include the same detection point is identified.

In step S1105, the smoothing unit 11 updates the mapping table using the pair of the tracking identifier and the subject identifier identified in step S1104.

In step S1106, the smoothing unit 11 identifies a subject identifier corresponding to a tracking identifier included in the tracking information acquired in step S1101 based on the mapping table.

In step S1107, the smoothing unit 11 outputs, to the accumulation unit 4, information indicating the combination of the tracking identifier and the subject identifier identified in step S1106.

Since the mapping table is updated in the order of imaging times by the above-described process, a subject identifier can still be identified for an imaging time lacking subject identification information using the most recently updated mapping table.

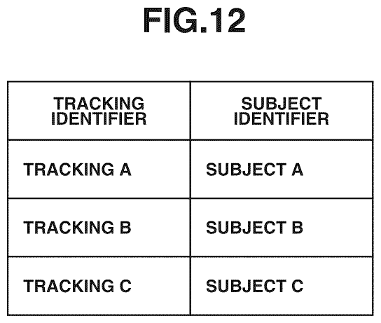

FIG. 12 is a diagram illustrating a mapping table indicating combinations of tracking identifiers and subject identifiers. Tracking A, tracking B, and tracking C, which are tracking identifiers, are associated with subject A, subject B, and subject C, which are subject identifiers. It should be noted that the above-described combinations are mere examples, and it is sufficient for one tracking identifier to be associated with one subject identifier. For example, tracking A may be associated with subject B. For an imaging time for which subject identification information is available, the mapping table is updated using tracking information and the subject identification information.

Although updating the mapping table is described as an example in the present exemplary embodiment, this is not intended to be limiting. For example, the smoothing unit 11 may retain the most recently obtained subject identification information corresponding to an imaging time preceding the processing target imaging time. In this case, the tracking identifier with which the most recently obtained subject identification information is associated is recorded, and based on this information, the subject identifier corresponding to the tracking identifier corresponding to the processing target imaging time is identified.

The above-described configuration facilitates subject tracking in various imaging environments. As described in the exemplary embodiment, a subject can be tracked even in an imaging environment with a sloped floor surface and height differences at certain positions. This enables the superimposition of a change in velocity or a subject trajectory based on tracking information and subject identification information as described above, thereby providing a virtual viewpoint image with high added value for analysis or viewing experience.

Although the accumulation unit 4 records tracking information and subject identification information in the present exemplary embodiment, this is not intended to be limiting. Tracking information and subject identification information may be recorded collectively as a unified piece of information. Specifically, position information about a detection point, a tracking identifier, and a subject identifier may be recorded in association with one another.

The present disclosure facilitates subject tracking in various imaging environments.

### Other Exemplary Embodiments

The above-described exemplary embodiment illustrates a specific exemplary embodiment for an image processing system and is not intended to be limiting.

For example, the subject position detection unit 8 may acquire a shape estimation result of the three-dimensional shape estimation unit 3 from the shape estimation results accumulated in the accumulation unit 4 by the three-dimensional shape estimation unit 3.

Although the exemplary embodiment employs a configuration that detects the highest point of the three-dimensional shapes within the predetermined region, a configuration that detects the lowest point may alternatively be employed. Specifically, a distance image is generated to observe the three-dimensional shapes from a lower viewpoint, and a point at which the distance is minimized (a point at which a local minimum occurs) within a predetermined range is detected as a detection point. This processing enables detection of a tire-ground contact surface in keirin. This facilitates subject position detection with reduced error regardless of how the athlete is postured. It should be noted that, in this case, since the detection point is in the vicinity of the tire-ground contact surface, it is desirable for the identification setting unit 10 to acquire color information from a position at a predetermined height from the position of the detection point if color information is to be acquired.

Although the tracking unit 9 refers to detection points from previous times and performs tracking in the above-described exemplary embodiment, the number of detection points output by the subject position detection unit 8 may be incorrect. For example, due to an estimation error in the three-dimensional shape estimation unit 3, detection by the subject position detection unit 8 may be inaccurate, and at certain imaging times, a detection point for a given subject may not be obtained, or an excessive number of detection points may be output.

Furthermore, a false shape generated from airborne dust may be detected. In consideration of such a case, it is desirable for the tracking unit 9 to perform the following process. In a case where a detection point disappears at the imaging time immediately preceding the processing target imaging time, the detection point is interpolated based on the assumption that the detection point at a previous imaging time continues to move in the travel direction while maintaining its previous velocity, and then tracking information is recorded in the accumulation unit 4. Further, in a case where a detection point that was not present at the previous imaging time appears, there may be a possibility of a false detection. Therefore, it is determined whether the detection point corresponds to a subject based on whether the detection point appears continuously (e.g., over 10 frames). In a case where it is determined that the detection point corresponds to a subject, a new tracking identifier is assigned to the detection point as a tracking start point and recorded in the accumulation unit 4. By performing the above-described process, the tracking unit 9 can appropriately manage increases or decreases in detection points.

Although the smoothing unit 11 acquires tracking information and subject identification information recorded in the accumulation unit 4 and verifies their correspondence in the above-described exemplary embodiment, this configuration is not necessarily intended to be limiting. For example, when generation of subject identification information is generated by the identification setting unit 10, the subject identification information may be re-recorded as tracking information to which a tracking identifier is assigned, in association with tracking identification information. This configuration facilitates the processing of the smoothing unit 11 using the information. However, in a case where an anomaly occurs in the tracking information or the subject identification information, it may become difficult to determine whether the anomaly has occurred in the tracking information or the subject identification information or to identify the cause. Therefore, it is desirable to record the information individually, and the smoothing unit 11 using the information desirably performs verification and correction.

Although the smoothing unit 11 is configured to include a detection point position smoothing unit and a velocity calculation unit in the above-described exemplary embodiment, the smoothing unit 11 does not necessarily need to include the velocity calculation unit, and a separate velocity calculation unit may alternatively be provided.

Although keirin is described as an example in the above-described exemplary embodiment, this is not intended to limit the imaging target to keirin. Applications to other imaging environments, such as sports competitions and concerts, are also feasible. In particular, since a hurdle race in track and field or an obstacle race involves a subject moving at a height above the floor surface, application of the present exemplary embodiment is likely to produce a favorable result.

Although the identification setting unit 10 automatically assigns a subject identifier to be set in the above-described exemplary embodiment, this is not necessarily intended to be limiting. The identification setting unit 10 may include a user interface, and based on a user operation, a subject identifier may be assigned to a detection point and recorded as subject identification information in the accumulation unit 4. An example of an assignment method in a case where a plurality of subjects is present will be described.

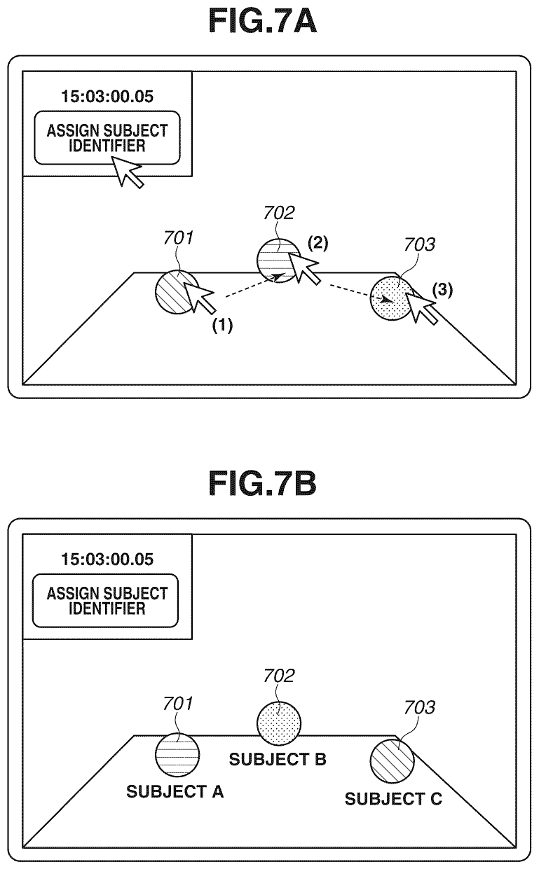

FIGS. 7A and 7B are diagrams illustrating display screens during assignment of subject identifiers to detection points based on user operations. For example, the user issues an instruction to change to a subject identifier assignment mode via a graphical user interface as illustrated in FIG. 7A. Detection points 701 to 703 detected by the subject position detection unit 8 are displayed on a screen as illustrated in FIG. 7A, and the user assigns a subject identifier by sequentially clicking on the detection points 701 to 703. Specifically, in the case of assigning subjects A to C, which are subject identifiers, to the detection points 701 to 703 in order, the user clicks on the detection points 701 to 703 in the same order. Using the order in which the detection points 701 to 703 are clicked as input, and the identification setting unit 10 assigns the identifiers based on that order as illustrated in FIG. 7B. Then, the identification setting unit 10 records information associating each detection point with a subject identifier as subject identification information in the accumulation unit 4. This enables the user to manually set an identifier even in a case where the identification setting unit 10 is not configured to automatically identify a subject or the subject contains only simple color information and cannot be identified.

Although the superimposition image generation unit 12 generates a superimposition image and the video generation unit 6 combines the superimposition image in the above-described exemplary embodiment, this is not necessarily intended to be limiting, and the video generation unit 6 may be configured to include the function of the superimposition image generation unit 12.

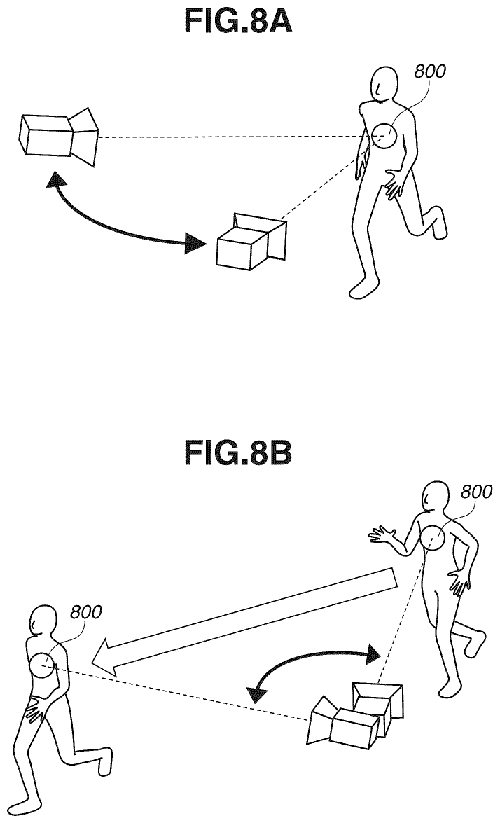

For example, the viewpoint instruction unit 5 may acquire and use tracking information and subject identification information accumulated in the accumulation unit 4. In this case, the viewpoint instruction unit 5 is configured to generate a virtual viewpoint capable of continuously orbiting around a subject even in a case where the subject moves, by setting a position 800 of a detection point of the subject as a position of a rotation center of the virtual viewpoint, for example, as illustrated in FIG. 8A. Further, the viewpoint instruction unit 5 may be configured to set a line-of-sight direction of the virtual viewpoint as the position 800 of the detection point of the subject, for example, as illustrated in FIG. 8B. In this case, the image processing system can generate a virtual viewpoint image based on a virtual viewpoint arranged at a semi-fixed position and configured to automatically rotate horizontally as the subject moves.

### Other Configurations

Each processing unit illustrated in FIG. 1 is described as being implemented in hardware in the above-described exemplary embodiment. However, each process performed by the processing units illustrated in FIG. 1 may be implemented using a computer program.

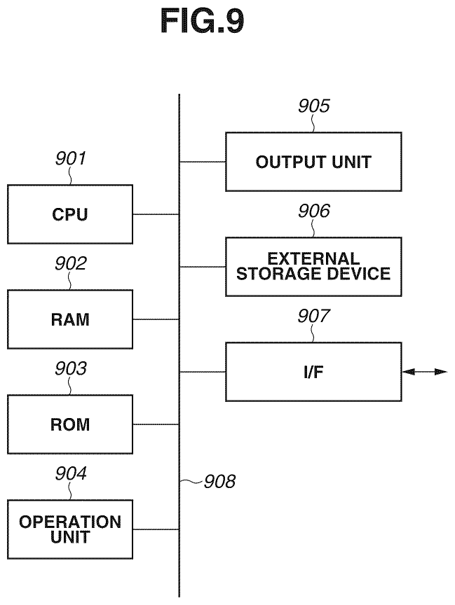

FIG. 9 is a block diagram illustrating an example of a hardware configuration of a computer applicable to the image processing apparatus according to the above-described exemplary embodiment.

A central processing unit (CPU) 901 controls the entire computer using a computer program and data stored in stored in a random access memory (RAM) 902 or a read-only memory (ROM) 903 and performs the processes described as being performed by the image processing apparatus according to the exemplary embodiment described above. In other words, the CPU 901 functions as each processing unit illustrated in FIG. 1.

The RAM 902 includes an area for temporarily storing a computer program or data loaded from an external storage device 906 or data acquired from an external source via an interface (I/F) 907. The RAM 902 further includes a work area used by the CPU 901 during execution of various processes. In other words, for example, the RAM 902 may be allocated as frame memory or used to provide various other areas as needed.

The ROM 903 stores setting data of the computer and a boot program. An operation unit 904 includes a keyboard and/or a mouse, and the user can input various instructions to the CPU 901 by operating the computer. An output unit 905 displays the results of processing performed by the CPU 901. Further, the output unit 905 includes, for example, a liquid crystal display. For example, the viewpoint instruction unit 5 includes the operation unit 904, and the display unit 7 includes the output unit 905.

The external storage device 906 is a high-capacity information storage device, such as a hard disk drive device. The external storage device 906 stores an operating system (OS) and a computer program for causing the CPU 901 to realize the function of each unit illustrated in FIG. 1. The external storage device 906 may also store image data to be processed.

The computer program or data stored in the external storage device 906 is loaded into the RAM 902 under the control of the CPU 901 as needed and is then processed by the CPU 901. A network, such as a local area network (LAN) or the Internet, or other devices, such as a projection device or a display device, may be connected to the I/F 907, and the computer can acquire and transmit various types of information via the I/F 907. In a first exemplary embodiment, each image capturing unit 1 is connected to the I/F 907 to input a captured image and/or to be controlled. A bus 908 connects the foregoing components.

The CPU 901 primarily controls the operation based on the above-described configuration as described in the exemplary embodiment.

In other configurations, the functions may also be realized by supplying a storage medium storing the computer program code for realizing the functions described above to a system and having the system read and execute the computer program code. In this case, the computer program code read from the storage medium realizes the functions of the exemplary embodiment described above, and the storage medium storing the computer program code constitutes the present disclosure. Further, a case where the operating system (OS) running on the computer performs part or all of the actual processing based on instructions from the program code to realize the functions through the processing is also encompassed.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-109384, filed Jul. 8, 2024, which is hereby incorporated by reference herein in its entirety.

What is claimed is:

1. An image processing apparatus comprising:
one or more memories storing instructions; and
one or more processors, that upon execution of the instructions, is configured to:
acquire first shape information representing a three-dimensional shape of a subject generated based on a plurality of captured images at a first imaging time and second shape information representing a three-dimensional shape of the subject generated based on a plurality of captured images at a second imaging time;
generate first distance information indicating a distance from a first position in a virtual space to the three-dimensional shape corresponding to the first shape information based on the first shape information and second distance information indicating a distance from a second position in the virtual space to the three-dimensional shape corresponding to the second shape information based on the second shape information;
set a first tracking point of the three-dimensional shape corresponding to the first shape information at the first imaging time based on the first distance information;
set a second tracking point of the three-dimensional shape corresponding to the second shape information at the second imaging time based on the second distance information; and
set a common identifier as an identifier set for the second tracking point as the identifier for the first tracking point when a distance between a position of the first tracking point and a position of the second tracking point is less than or equal to a predetermined value.

2. The image processing apparatus according to claim 1,
wherein the first distance information uses the first shape information to indicate a distance from the first position to a plurality of first components constituting the three-dimensional shape, and
wherein the second distance information uses the second shape information to indicate a distance from the second position to a plurality of second components constituting the three-dimensional shape.

3. The image processing apparatus according to claim 2,
wherein the first tracking point is a first component with a shortest or greatest distance among the plurality of first components, and
wherein the second tracking point is a second component with a shortest or greatest distance among the plurality of second components.

4. The image processing apparatus according to claim 2,
wherein the first tracking point is a first component included within a predetermined region among the plurality of first components, and
wherein the second tracking point is a second component included within a predetermined region among the plurality of second components.

5. The image processing apparatus according to claim 2,
wherein the plurality of first components and the plurality of second components are classified into a plurality of regions, and
wherein the first tracking point and the second tracking point are set for each of the plurality of regions.

6. The image processing apparatus according to claim 5, wherein execution of the stored instructions further configures the one or more processors to collectively set, as a single third tracking point, the plurality of first tracking points included within a predetermined range from among the plurality of first tracking points set for each of the plurality of regions.

7. The image processing apparatus according to claim 6, wherein a position of the third tracking point is a centroid position of the plurality of first tracking points included within the predetermined range.

8. The image processing apparatus according to claim 6, wherein the predetermined range is a range centered on the first tracking point.

9. The image processing apparatus according to claim 6, wherein the predetermined range differs for each imaging target.

10. The image processing apparatus according to claim 6,
wherein the imaging target is keirin, and
wherein the predetermined range is set along a track course of a keirin velodrome.

11. The image processing apparatus according to claim 1,
wherein the first shape information represents a three-dimensional shape of a plurality of subjects, and
wherein a same number of first tracking points as a number of the plurality of subjects is set.

12. The image processing apparatus according to claim 1, wherein the first position is generated based on a bounding box enclosing the three-dimensional shape corresponding to the first shape information.

13. The image processing apparatus according to claim 12, wherein the first position is set at a position at a predetermined distance from a center of an upper surface of the bounding box.

14. The image processing apparatus according to claim 1, wherein the first position is set based on a three-dimensional shape of a background specified based on a position of the three-dimensional shape corresponding to the first shape information.

15. The image processing apparatus according to claim 14,
wherein the three-dimensional shape of the background represents a keirin velodrome; and
wherein the first distance information indicates a distance from the first position to the three-dimensional shape corresponding to the first shape information in a direction perpendicular to a track course of the keirin velodrome where the three-dimensional shape corresponding to the first shape information is positioned.

16. The image processing apparatus according to claim 1, wherein execution of the instructions further configures the one or more processors to output position information indicating the position of the first tracking point and information indicating the identifier.

17. An image processing method comprising:
acquiring first shape information representing a three-dimensional shape of a subject generated based on a plurality of captured images at a first imaging time and second shape information representing a three-dimensional shape of the subject generated based on a plurality of captured images at a second imaging time;
generating first distance information indicating a distance from a first position in a virtual space to the three-dimensional shape corresponding to the first shape information based on the first shape information and second distance information indicating a distance from a second position in the virtual space to the three-dimensional shape corresponding to the second shape information based on the second shape information;
setting a first tracking point of the three-dimensional shape corresponding to the first shape information at the first imaging time based on the first distance information,
setting a second tracking point of the three-dimensional shape corresponding to the second shape information at the second imaging time based on the second distance information; and
setting a common identifier as an identifier set for the second tracking point as the identifier for the first tracking point when a distance between a position of the first tracking point and a position of the second tracking point is less than or equal to a predetermined value.

18. A non-transitory computer-readable storage medium storing a program for causing a computer that has a display unit to execute a control method of an image display apparatus comprising:
acquiring first shape information representing a three-dimensional shape of a subject generated based on a plurality of captured images at a first imaging time and second shape information representing a three-dimensional shape of the subject generated based on a plurality of captured images at a second imaging time;
generating first distance information indicating a distance from a first position in a virtual space to the three-dimensional shape corresponding to the first shape information based on the first shape information and second distance information indicating a distance from a second position in the virtual space to the three-dimensional shape corresponding to the second shape information based on the second shape information;
setting a first tracking point of the three-dimensional shape corresponding to the first shape information at the first imaging time based on the first distance information,
setting a second tracking point of the three-dimensional shape corresponding to the second shape information at the second imaging time based on the second distance information, and
setting a common identifier as an identifier set for the second tracking point as the identifier for the first tracking point when a distance between a position of the first tracking point and a position of the second tracking point is less than or equal to a predetermined value.
